(19) United States
(12) Patent Application Publication
(10) Pub. No.: US 2012/0078036 A1
(43) Pub. Date: Mar. 29, 2012

(54) PROBE FOR ARTIFICIAL INSEMINATION, IN PARTICULAR FOR PIGS

(75) Inventor: Jean Francois Yvoz, Steenvoorde (FR)

(73) Assignee: ECOPOR, Hazebrouck (FR)

(21) Appl. No.: 13/376,290

(22) PCT Filed: Jun. 4, 2010
(86) PCT No.: PCT/FR2010/051108

§ 371 Date: Dec. 5, 2011

(30) Foreign Application Priority Data
Jun. 5, 2009 (FR) 0953749

(51) Int. Cl. A61D 19/02

(52) U.S. Cl. 600/35

(57) ABSTRACT

The present invention relates to a probe for artificially inseminating an animal, including: a cylindrical body to be inserted inside the vagina of the animal and ending in a distal element provided with a discharge opening; and a storage space for semen to be injected. The cylindrical body consists of a hollow tube, and the storage space comprises a flexible tube that is molded onto the proximal end of the cylindrical body on one side and onto a plug on the other side, said plug allowing the storage space to be filled under pressure. In the inoperative position, after being filled, the semen is located mainly in the expanded flexible tube while an overpressure prevails inside the cylindrical body. In the operative position, when the flexible tube is outside the vagina of the animal, the semen is moved into the entire cylindrical body through the discharge opening under the effect of suction and of the contraction of the flexible tube returning to the original volume thereof.

This is a 371 national phase application of PCT/FR2010/051108 filed 4 Jun. 2010, which claims priority to French Patent Application No. 0953749 filed 5 Jun. 2009, the contents of which are incorporated herein by reference.

### FIELD OF THE INVENTION

The present invention relates to a device specially designed for the artificial insemination of an animal, in particular pigs.

### BACKGROUND OF THE INVENTION

Different techniques and therefore devices exist for artificial insemination, which differ in particular by the packaging mode of the animal semen. For example, the injection pistol described in document FR 2,358,136 is designed to inject the semen from different available packaging modes, in particular doses in straws, of the French, German or American type. In this technique, the operator performing the insemination of the animal must manipulate the packaging to insert it into the pistol.

According to another technique described in document FR 2,450,103, the artificial insemination device comprises, on the one hand, a cylindrical body at least a portion of which is intended to be inserted inside the vagina of the animal and ending in a distal end provided with a discharge opening and, on the other hand, a storage space for semen to be injected, this storage space being made up of an enclosure that surrounds the cylindrical body and communicates with the discharge opening. In the inactive position, the enclosure is applied in the non-expanded state around the cylindrical body. Once the latter is inserted, with the distal end, inside the vagina of the animal, the desired dose of sperm is inserted as far as inside the enclosure. The expansion of the enclosure, due to its filling, causes it to be pressed on the inner wall of the vagina. It should be noted that according to this technique, the connection of the enclosure with the discharge opening is done using a mechanical system implementing a hollow tube slidingly mounted inside the cylindrical body and having lumens for connecting to the inside of the enclosure. Thus, according to this technique described in document FR 2,450,103, the filling of the artificial insemination device with the animal semen is done at the insemination location while the device is already inserted into the vagina of the animal. This is a major drawback due to the potential risks caused by the handling that it requires.

Document WO 2008/055665 seeks to offset this drawback. It describes an artificial insemination probe that comprises a hollow shaft and a deformable enclosure delimiting, with the hollow shaft, a reservoir for the semen. The hollow shaft and the enclosure are inserted into the genitalia of the animal. The hollow shaft includes a filling opening for inserting semen into the reservoir and a discharge opening for discharging the semen contained in the reservoir. The enclosure is molded onto the entire hollow shaft. Thus, for it to be able to form a reservoir between the enclosure and the hollow shaft, it is provided that the hollow shaft comprises, in a tubular portion, at least one longitudinal opening. During filling, the part of the enclosure that overhangs said longitudinal opening expands, so that during the insertion of the probe, this expanded enclosure portion comes into contact with the body of the animal. As a result, the insertion of the probe does not respect the well-being of the animal. The same is also true with the device of document FR 2,450,103 mentioned above.

Furthermore, in this document WO 2008/055665, once the operator has inserted the probe into the animal, he must wait for the semen to flow from the reservoir toward the discharge opening before removing the probe and disposing of it. It is of course necessary make sure that the majority of the semen has flowed for greater insemination effectiveness, so that the operator tends to leave the probe in place for a longer period of time than is strictly necessary, or he runs the risk of leaving too much residual semen in the probe.

Furthermore, the hollow shaft of the probe, with its filling opening, discharge opening and tubular portion including a longitudinal opening able to form the reservoir in combination with the enclosure, is complex to manufacture. Furthermore, the placement of the enclosure on the entire length of the hollow shaft is difficult, with risks of sealing flaws.

### SUMMARY OF THE INVENTION

The aim of the present invention is to propose an artificial insemination probe that offsets all or some of the drawbacks of the aforementioned techniques.

This aim is fully achieved by a probe for artificially inseminating an animal, in particular pigs, that comprises, in a manner known by document FR 2,450,103, on the one hand, a cylindrical body to be inserted inside the vagina of the animal and ending in a distal element provided with a discharge opening and on the other hand, a storage space for semen to be injected.

According to the present invention, characteristically, the cylindrical body is made up of a hollow tube, in particular semi-rigid, and the storage space is made up of a flexible tube, elastically deformable and impermeable to air, which is molded on the one hand onto the proximal end of the cylindrical body and the other onto a plug that can allow the storage space to be filled under pressure. The distal end contains a material, in particular a wax, that, solid at ambient temperature, plugs the discharge opening in the inactive position of the probe and, liquefying at the internal temperature of the animal, makes it possible to free the opening in the active position of the probe inserted inside the vagina of the animal. Lastly, in the inactive position, after filling, the semen is located primarily in the expanded flexible tube and an overpressure prevails inside the cylindrical body and, in the active position, the flexible tube being outside the vagina of the animal, the semen is moved in the entire cylindrical body through the discharge opening, in particular by a suction phenomenon and under the effect of the contraction of the flexible tube returning to its original form.

Thus, according to the particular measures of the present invention, the semen storage space is located outside the portion of the probe as it is inserted inside the vagina of the animal so that, on the one hand, there is no contact between said capacity and the body of the animal during the insertion or during the insemination strictly speaking—which facilitates the placement of the probe and respects the well-being of the animal—and, on the other hand, the operator can view whether any semen remains inside said space and remove the probe with full knowledge of the facts.

In one alternative embodiment, the cylindrical body is a semi-rigid hollow polypropylene tube and the flexible tube is made from elastomer, in particular a styrene-ethylene-butylene-styrene (SEBS) block copolymer.

The plug can include:
a stopper support onto which the proximal end of the flexible tube is molded and which includes an axial opening, and
a stopper that can close said opening.

In one embodiment, the closing of the axial opening by the stopper is done after filling the storage space with the semen.

In another embodiment, the stopper is made from a flexible material that can be pierced by a semen filling injector, of the needle type, and which can be sealably closed upon removal of the injector. In this case, the material to form the stopper can in particular be elastomer, preferably styrene-ethylene-butylene-styrene (SEBS) like the flexible tube.

According to one alternative embodiment, the distal element of the probe is a rigid tube in the rear portion of which the distal end of the cylindrical body is fitted and which includes an inner shoulder intended to serve as a stop for said distal end.

According to one alternative embodiment, the plug material is contained in a hollow tip that is fitted into the front portion of the distal element and that includes an extension coming outside the distal element and covering the discharge opening. Furthermore, said extension is frangible so as to free the discharge opening during use of the probe.

According to one alternative embodiment, the probe includes at least one flexible sealing skirt, positioned around the distal element.

Preferably, this skirt is incorporated into a sleeve that is molded onto the distal element and the front portion of the cylindrical body. The purpose of this skirt is to maintain the sealing of the uterine environment, between the genital tissues and the probe. It in particular ensures that the semen that flows through the discharge opening of the probe is not discharged toward the back, but indeed penetrates the uterus. Preferably, the skirt is formed from the front to the back of the sleeve following a succession of at least two series, a first series in which the diameter decreases and a second series in which the diameter increases. The optimal placement of the probe is obtained when the cervix of the animal is positioned at the smallest diameter of the two series.

According to one particular embodiment, the sleeve bears a single skirt assuming a spiral configuration and the diameter of which evolves over the length of the sleeve, in particular along the two aforementioned series.

According to one alternative embodiment, the plugging material, which is solid at ambient temperature and liquefies at the internal temperature of the animal, contains at least one active agent relative to at least one component of the semen, in particular the spermatozoids; it may in particular be an agent favoring the motility of the spermatozoids.

Another aim of the invention is to propose an artificial insemination device that includes a probe having all or some of the features mentioned above as well as a sanitary pouch for storing said probe. Characteristically, the distal element, the cylindrical body and the flexible tube of the probe being placed inside the pouch, the latter is fixed in particular by thermowelding on the stopper support. The filling of the probe can thus occur while the essential portions of the probe are protected by the sanitary pouch. Once the filling is done, said device can be delivered to the operator under perfect hygiene and safety conditions, in particular regarding the preservation of the semen.

### BRIEF DESCRIPTION OF THE DRAWINGS

The present invention will be better understood upon reading the description of one preferred example of a probe for artificial insemination illustrated by the appended drawing, in which:

FIG. 1 is a diagrammatic illustration of the probe before filling,

FIG. 2 is a diagrammatic illustration of the probe of FIG. 1 after filling,

FIG. 3 is a diagrammatic illustration in longitudinal cross-section of a probe that essentially differs from that of FIG. 1 by the spiral configuration of the sealing skirt.

### DETAILED DESCRIPTION

The artificial insemination probe described below is intended in particular for the insemination of pigs, regarding sows and gilts. This use is not, however, limiting.

In this text, the notions of front and back as well as proximal and distal are considered in the general direction of insertion of the probe into the animal.

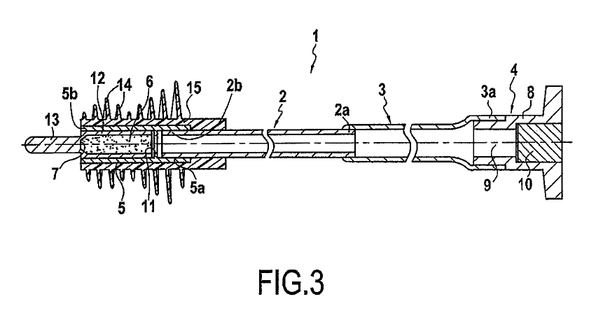

The probe 1 is a single-piece assembly that comprises a cylindrical body 2, similar to a catheter, that is a hollow tube in a semi-rigid plastic material, in particular polypropylene. This hollow tube is extended backward by a flexible tube 3 that can be deformed when it is placed under pressure and that is impermeable to air. This flexible tube 3 is molded onto the proximal end 2a of the cylindrical body 2. The flexible tube 3 is extended backward by a plug 4 that is made up of a stopper support 8 that is a hollow rigid piece whereof the axial opening 9, serving to fill the probe 1 with the animal semen, opens to the inside of the flexible tube 3 and consequently also of the cylindrical body 2. This axial opening 9 is, in FIG. 3, closed by a stopper 10.

The plug element 4 can comprise, at its stopper support 8, inner marks that can cooperate with free strips formed around the stopper 10. Thus, the marks mechanically block the stopper 10 so as to prevent the latter from rising back toward the opening of the stopper support 8 when an overpressure is exerted inside the flexible tube 3.

Furthermore, it is possible to provide that the flexible tube 3 is molded onto the proximal end 2a of the cylindrical body 2 on at least one third of its length, preferably on more than one third, and less than half of the length of the cylindrical body 2, in order to shift the formation of the cuff when the tube 3 is inflated toward the plug 4.

This arrangement makes it possible for the cylindrical body 2 to be perfectly inserted into the genitalia of the animal.

The flexible tube 3 can also include a local overthickness of material (not shown in the figures, for example in the vicinity of 0.4 mm for 10 mm, in order to offset the formation of the balloon when the tube 3 is inflated toward the plug 4, the balloon forming between the overthickness on the one hand, and the plug 4 on the other hand.

This local overthickness is preferably formed at the inner diameter of the flexible tube 3, but could also be formed at the outer diameter of said flexible tube 3.

The proximal end 3a of the flexible tube 3 is also molded onto the stopper support 8 of the plug 4.

It is also possible to provide a stop skirt 16 at the distal end of the flexible tube 3 that is molded onto the proximal end 2a of the cylindrical body 2. This stop skirt 16 is preferably overmolded on the distal end of the flexible tube 3.

The purpose of this stop skirt 16 is to help with the placement of the probe 1 in order to ensure that the distal element 5 is well-positioned at the cervix.

This stop skirt 16 also favors the catching of the probe 1 inside the genitalia of the animal.

Thus, this stop skirt 16 can be inserted into the genitalia of the animal via a pusher positioned between the skirt and the cuff formed when the flexible tube 3 is inflated as shown in FIG. 3. The purpose of the pusher is to deform the stop skirt 16 so that the latter can be inserted inside the genitalia of the animal.

The probe 1 also includes a distal element 5 that is a rigid tubular piece in which the distal end 2b of the cylindrical body 2 is fitted. This distal element 5 includes an inner shoulder 11 that serves as a stop for the hollow body 2 during its insertion into the distal element 5.

The probe 1 includes a discharge opening 7, which in this case is made up of the inside recess of the distal element 5 in its end portion. This discharge opening 7 is plugged by a material 6 that is solid at ambient temperature and liquefies at the temperature prevailing inside the vagina of the animal. This may in particular be a wax known by the name WITEPSOL® W25.

To avoid any alteration of this material before using the probe, in the embodiment illustrated in FIG. 3, this material 6 is contained in a hollow tip 12 that is fitted into the front portion 5b of the distal element 5, as far as the shoulder 11 that also serves as a stop, and which includes an extension 13 coming to the outside of the distal element 5 and covering the discharge opening 7. This extension 13 is frangible so that the discharge opening is freed by sectioning said extension, immediately before using the probe.

The distal element 5 also comprises an annular extension 17 surrounding the frangible end 13 so that the semen is correctly poured at the desired location and does not flow on the distal element 5.

Furthermore, the hollow tip 12 includes a hammered proximal end so as to curve its outer periphery around the plug material 6 and prevent the wax, as a function of the storage conditions, from flowing through the hollow end 12 toward the inside of the cylindrical body 2.

The distal element 5 and the portion of the cylindrical body 2 located behind the distal element are covered, by molding, with a sleeve comprising at least one skirt 14. This sleeve 15, including the skirt(s) 14, is made from a flexible material, in particular elastomer and preferably SEBS.

The molding of the sleeve 15 onto the distal element 5 and partially onto the cylindrical body 2, like the molding of the flexible tube 3 onto the proximal end 2a of the cylindrical body 2 and onto the stopper support 8, makes it possible to obtain very good securing of these different elements to one another and especially complete sealing, making it possible to ensure excellent preservation of the semen once it has been introduced into the probe.

The filling of the probe can be done in two ways depending on the filling material one has. If this material includes a needle-type injector, the stopper 10 covering the axial opening 9 of the stopper support 8 is in a material that on the one hand can be pierced by the injector and on the other hand can close sealably when the injector is removed. This may be an elastomer, and in particular SEBS.

According to another route, the stopper 10 is only inserted into the axial opening 9 after said filling has been done.

In that case, the material of the stopper 10 is not necessarily of the type that can be pierced by the injector and can close sealably when the injector is removed. It is in fact possible to use a stopper 10 made from a rigid material, such as polypropylene, which is positioned after filling to cover the axial opening 9 of the stopper support 8. This positioning after filling can be done automatically, in particular in the context of an automated filling method.

Whatever the case may be, due to the quantity of semen injected under pressure during filling of the probe, a double phenomenon occurs, i.e. expansion of the flexible tube 3 in the zone that extends between the two ends serving for molding, as illustrated in FIG. 2, and on the other hand the formation of an overpressure in the cylindrical body 2. It should be noted that the semen is primarily located in the expanded flexible tube 3, which can nevertheless partially occupy the cylindrical tube 2. This distribution can also evolve over time between the filing and use of the probe.

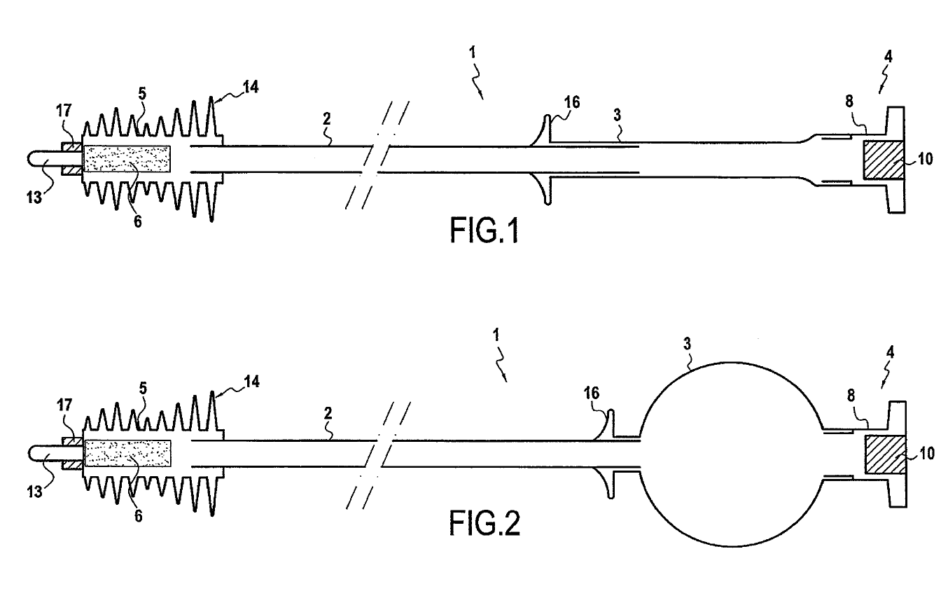

In the example illustrated in FIG. 3, the sleeve 15 includes a single skirt that assumes a spiral configuration and the diameter of which evolves over the length of the sleeve. This evolution is progressive on a first series 14.1 corresponding to several turns, then it is degressive on a second series 14.2 also corresponding to several turns, and lastly it is progressive again on a third series 14.3 corresponding to several turns. The optimal positioning of the probe 1 in the animal is obtained when the turns with the larger diameter are situated on either side of the cervix, which makes it possible to obtain maximum sealing. Of course, it would be possible to obtain the same effect by using not a single spiral skirt, but a plurality of annular skirts spaced apart from one another on the length of the sleeve 15, as illustrated in FIG. 1.

The ensure the protection of the probe before and after it is filled, it can be stored in a sanitary pouch. More specifically, this pouch is made from a thermoplastic material and is sized to contain the distal element, the cylindrical body and the hollow tube, while it is thermowelded, for example by ultrasound, around the stopper support 8, immediately behind the molding by the flexible tube 3. The filling of the probe 1 with the semen can therefore be done while the probe is stored in its sanitary pouch.

To implement the probe, the operator separates the sanitary pouch from the probe, knowing that precuts formed in the pouch can facilitate that operation. The operator grasps the frangible extension 13 and separates it from the tip 12, thereby freeing the discharge opening 7, which is covered by the material 6. He then inserts the probe into the animal while positioning it optimally as mentioned above. The total length of the distal element and the cylindrical body is determined so that the flexible tube 3 remains outside the animal. Given the temperature prevailing inside the animal, the material 6 gradually liquefies, freeing the passage of the discharge opening 4. Due to the overpressure existing inside the cylindrical body 2, this release of the discharge opening 4 creates a suction phenomenon that causes the semen contained inside the flexible tube 3 and possibly the cylindrical body 2 to move toward the discharge opening 7 and causes it to flow into the uterus of the animal. This movement also occurs due to the fact that the flexible tube 3, freed from the overpressure, tends to return to its initial volume. It is also caused by a suction phenomenon due to the natural movements of the uterine wall.

Given that the flexible tube 3 remains outside the animal, it is possible for the operator to observe the behavior of said flexible tube 3 during the insemination. One will see that at the end of insemination, the flexible tube 3 at least partially assumes a flat shape, which could mean that a certain vacuum forms inside the probe. One can see that when this phenomenon occurs, the residual quantity of semen in the probe is only several millimeters for a quantity of semen inserted into the probe of about 85 ml.

The plug material 6, once liquefied, comes into contact with the semen that moves through the hollow tip 12 and the discharge opening 7. This contact can be used by adding an active ingredient into said material that acts on one of the components of the semen, in particular an active ingredient that acts on the motility of the spermatozoids. Comparative tests have made it possible to confirm the excellent preservation of the semen as well as the improved motility of the spermatozoids contained in said semen. Furthermore, on a series of tests, all of the inseminations done have obtained positive results, sows having been diagnosed pregnant 21 days after insemination.

1. A probe for artificially inseminating an animal, in particular pigs, comprising:
a cylindrical body to be inserted inside the vagina of the animal and ending in a distal element provided with a discharge opening, and
a storage space for semen to be injected,
a plug that can allow the storage space to be filled under pressure, wherein:
the cylindrical body is made up of a hollow tube, in particular semi-rigid,
the storage space is made up of a flexible tube, elastically deformable and impermeable to air, which is molded on the one hand onto the proximal end of the cylindrical body and the other onto said plug,
the distal element contains a plugging material, in particular a wax, that, solid at ambient temperature, plugs the discharge opening in the inactive position of the probe and, liquefying at the internal temperature of the animal, makes it possible to free the opening in the active position of the probe inserted inside the vagina of the animal,
in the inactive position, after filling, the semen is located primarily in the then-expanded flexible tube and an overpressure prevails inside the cylindrical body, and
in the active position, the flexible tube being outside the vagina of the animal, the semen is moved in the entire cylindrical body through the discharge opening by suction and under the effect of the contraction of the flexible tube returning to its original form.

2. The probe according to claim 1, wherein the cylindrical body is a semi-rigid hollow polypropylene tube and the flexible tube is made from elastomer, in particular a styrene-ethylene-butylene-styrene (SEBS) block copolymer.

3. The probe according to claim 1, wherein the plug includes:
a stopper support, onto which the proximal end of the flexible tube is molded, and including an axial opening, and
a stopper that can close said opening, in particular after filling.

4. The probe according to claim 1, wherein the stopper is made from a flexible material that can be pierced by a semen filling injector, of the needle type, and which can be sealably closed upon removal of the injector, in particular an elastomer, preferably a styrene-ethylene-butylene-styrene (SEBS) block copolymer.

5. The probe according to claim 1, wherein the distal element of the probe is a rigid tube in the rear portion of which the distal end of the cylindrical body is fitted and which includes an inner shoulder intended to serve as a stop for said distal end.

6. The probe according to claim 5, wherein the plug material is contained in a hollow tip that is fitted into the front portion of the distal element and that includes an extension coming outside the distal element and covering the discharge opening and in that said extension is frangible so as to free the discharge opening during use of the probe.

7. The probe according to claim 1, wherein the probe includes at least one flexible sealing skirt, positioned around the distal element.

8. The probe according to claim 7, wherein the skirt is incorporated into a sleeve that is molded onto the distal element and the front portion of the cylindrical body, in particular in elastomer, preferably SEBS.

9. The probe according to claim 8, wherein the skirt is formed from the front to the back of the sleeve following a succession of at least two series, a first series in which the diameter decreases and a second series in which the diameter increases.

10. The probe according to claim 8, wherein the sleeve bears a single skirt assuming a spiral configuration and the diameter of which evolves over the length of the sleeve, in particular along the two series.

11. The probe according to claim 1, wherein the plugging material contains at least one active agent relative to at least one component of the semen, in particular spermatozoid.

12. A device for artificial insemination including a probe according to claim 3 and a sanitary pouch for storing said probe, wherein the distal element, the cylindrical body and the flexible tube being placed inside the pouch, the pouch is fixed, in particular thermowelded, on the stopper support.
